(19) United States
(12) Patent Application Publication
(10) Pub. No.: US 2016/0221261 A1
(43) Pub. Date: Aug. 4, 2016

(54) Three-Dimensional Shaping Device and Three-Dimensional Shaping Method

(71) Applicant: KONICA MINOLTA, INC., Tokyo (JP)

(72) Inventors: Naoki YAMAMOTO, Aichi (JP); Takeo OSHIBA, Tokyo (JP); Takuya ISHIGAI, Tokyo (JP); Wataru ONODA, Tokyo (JP)

(73) Assignee: Konica Minolta, Inc., Tokyo (JP)

(21) Appl. No.: 15/025,593

(22) PCT Filed: Sep. 10, 2014
(86) PCT No.: PCT/JP2014/004636

§ 371 Date: Mar. 29, 2016

(30) Foreign Application Priority Data
Oct. 3, 2013 (JP) 2013-208327

(51) Int. Cl. B29C 67/00

(52) U.S. Cl. CPC B29C 67/0059; B29C 67/0055; B29C 67/0092; B29K 2105/0061

(57) ABSTRACT

The three-dimensional shaping device is provided with: a first forming section for forming the outline (210) of a shaping material layer at a first resolution by discharging the shaping material toward a shaping stage; and a discharge part and a curing part that configure a second forming section for forming the inside of the outline (210) at a second resolution that is lower than the first resolution by discharging a shaping material (182) toward the shaping stage.

### TECHNICAL FIELD

The present invention relates to a three-dimensional shaping apparatus and a three-dimensional shaping method.

### BACKGROUND ART

A technique called rapid prototyping (RP) is known as a technique of shaping a three-dimensional article (hereinafter referred to as “three-dimensional object”). This technique is a technique of shaping a three-dimensional object by using data (data of STL (Standard Triangulated Language) format) describing the surface of one three-dimensional object as a collection of triangles, by calculating a cross-sectional shape thinly cut in the lamination direction, and by forming each layer in accordance with the shape. In addition, known examples of methods of shaping a three-dimensional object include fused deposition molding (FDM), ink-jet methods, ink-jet binder methods, stereo lithography (SL), selective laser sintering (SLS) and the like.

An example of the three-dimensional shaping method of the ink-jet method is a technique of shaping a three-dimensional object in which one shaping material layer (cured layer) is formed through a step of selectively discharging a shaping material (for example, photosetting resin) from an ink-jet head to a shaping stage, a step of flattening the surface, and a step of curing the shaping material (in the case of a photosetting resin, light irradiation step), and a plurality of the shaping material layers are stacked on one another to thereby shaping a three-dimensional object, for example. With this method, high-definition shaping material layers are formed by discharging a shaping material in the form of micro droplets, and thus a high-definition three-dimensional object can be shaped by stacking the high-definition shaping material layers on one another. In addition, an ink-jet head (so-called line head) in which a plurality of discharging nozzles are arranged is used as the ink-jet head so that even a large three-dimensional object can be shaped in a relatively short time.

In recent years, it is desired to shape a three-dimensional object with a high definition, or more specifically, with a resolution of 600 [dpi] (600 [dot] per inch at approximately 42 [μm] pitch) or greater. High-resolution of a three-dimensional object in the lamination direction can be achieved by reducing the lowering amount of the shaping stage or the lifting amount of the ink-jet head (sending pitch). In addition, high-resolution of the main scanning direction (a direction orthogonal to the direction in which discharging nozzles are arranged) can be achieved by increasing the frequency of the voltage (discharging frequency) to be applied to the ink-jet head, or by reducing the scanning speed of the shaping stage and the ink-jet head.

In addition, high-resolution in the sub scanning direction (a direction parallel to the direction in which discharging nozzles are arranged) can be achieved by increasing the nozzle resolution of the ink-jet head, that is, by reducing the nozzle pitch. However, increase of the nozzle resolution of the ink-jet head is limited, and currently used nozzle resolution is merely about 100 [dpi] (100 nozzles per inch at approximately 0.25 [mm] pitch). In view of this, conventionally, after a first operation of discharging the shaping material while scanning in the main scanning direction, a second operation in which scanning is performed in the sub scanning direction at a pitch equal to or smaller than the nozzle pitch such that the discharging centers of the shaping material do not overlap is performed (that is, the discharging position is shifted to a position between nozzles), and the first operation and the second operation are repeated to increase the resolution in the sub scanning direction.

PTL 1 discloses a technique in which the arranging direction of orifices (discharging nozzles) in a print head (ink-jet head) and the scanning direction of the print head are oriented at a certain angle such that the shaping material can be discharged at an interval smaller than a nozzle pitch.

### CITATION LIST

### Patent Literature

PTL 1

Japanese Patent Application Laid-Open No. 2004-130817

### SUMMARY OF INVENTION

### Technical Problem

However, the above-mentioned approach intended for increasing the resolution of a three-dimensional object may result in decrease in shaping speed of the three-dimensional object. For example, when increasing the resolution in the sub scanning direction by repeating the first operation and the second operation, the discharging frequency of the shaping material is required to be increased, and consequently the shaping speed of the three-dimensional object is reduced by the increased frequency.

An object of the present invention is to provide a three-dimensional shaping apparatus and a three-dimensional shaping method which can increase the resolution of a three-dimensional object without reducing the shaping speed of the three-dimensional object.

### Solution to Problem

A three-dimensional shaping apparatus according to the present invention includes: a shaping stage on which a shaping material layer made of a shaping material is formed; a first formation section including a first discharging nozzle configured to discharge the shaping material, the first formation section being configured to discharge the shaping material from the first discharging nozzle toward the shaping stage to form an outline of the shaping material layer with a first resolution; and a second formation section configured to supply the shaping material to the shaping stage to form an inner portion of the outline with a second resolution lower than the first resolution, in which the shaping material is supplied from the first formation section and the second formation section onto the shaping stage, and a plurality of shaping material layers are formed and stacked on one another to shape a three-dimensional object.

A three-dimensional shaping method of shaping a three-dimensional object according to the present invention includes: forming an outline of a shaping material layer with a first resolution by discharging a shaping material toward a shaping stage; forming an inner portion of the outline with a second resolution lower than the first resolution by supplying the shaping material toward the shaping stage; and forming and stacking a plurality of shaping material layers on one another.

### Advantageous Effects of Invention

According to the present invention, an outline of a shaping material layer which is related to the appearance of a three-dimensional object and is therefore required to be formed with a high resolution is formed with a resolution higher than the resolution of the inner portion of the outline, whereas the inner portion of the outline which is not related to the appearance and is therefore is not required to be formed with a high resolution is formed with a formation speed higher than that of the outline. Thus, the resolution of the shaping material layer can be increased without reducing the formation speed of the shaping material layer, and in turn, the resolution of the three-dimensional object can be increased without reducing the shaping speed of the three-dimensional object.

### BRIEF DESCRIPTION OF DRAWINGS

FIG. 1 schematically illustrates a configuration of a three-dimensional shaping apparatus according to a first embodiment;

FIG. 2 illustrates a principal part of a control system of the three-dimensional shaping apparatus according to the first embodiment;

FIGS. 3A to 3C illustrate a configuration of a first formation section according to the first embodiment, and specifically, FIG. 3A is a side view of an interior of a housing, FIG. 3B is a bottom view, and FIG. 3C illustrates a case where the first formation section has a double structure of a part for a model material and a part for a supporting material;

FIGS. 4A to 4C illustrate a configuration of a second formation section according to the first embodiment, and specifically, FIG. 4A is a side view of an interior of a housing, FIG. 4B is a bottom view, and FIG. 4C illustrates a case where the second formation section has a double structure of a part for a model material and a part for a supporting material;

FIG. 5 illustrates a configuration of a curing section according to the first embodiment;

FIGS. 6A to 6J schematically illustrate an operation of forming one shaping material layer;

FIG. 7 schematically illustrates a configuration of a three-dimensional shaping apparatus according to a second embodiment;

FIGS. 8A to 8C illustrate a configuration of a second formation section according to the second embodiment, and specifically, FIG. 8A is a side view of an interior of a housing, FIG. 8B is a bottom view, and FIG. 8C illustrates a case where the second formation section has a double structure of a part for a model material and a part for a supporting material;

FIGS. 9A to 9D illustrate an operation of the second formation section according to the second embodiment;

FIG. 10 illustrates a configuration of the second formation section according to a third embodiment;

FIGS. 11A to 11C illustrate an operation of the second formation section according to the third embodiment;

FIG. 12 shows temperature dependency of the viscosity of a shaping material having a sol-gel phase transition temperature; and

FIG. 13 illustrates a configuration of a heating section that heats a discharging head.

### DESCRIPTION OF EMBODIMENTS

In the following, a first embodiment will be described in detail with reference to the accompanying drawings.

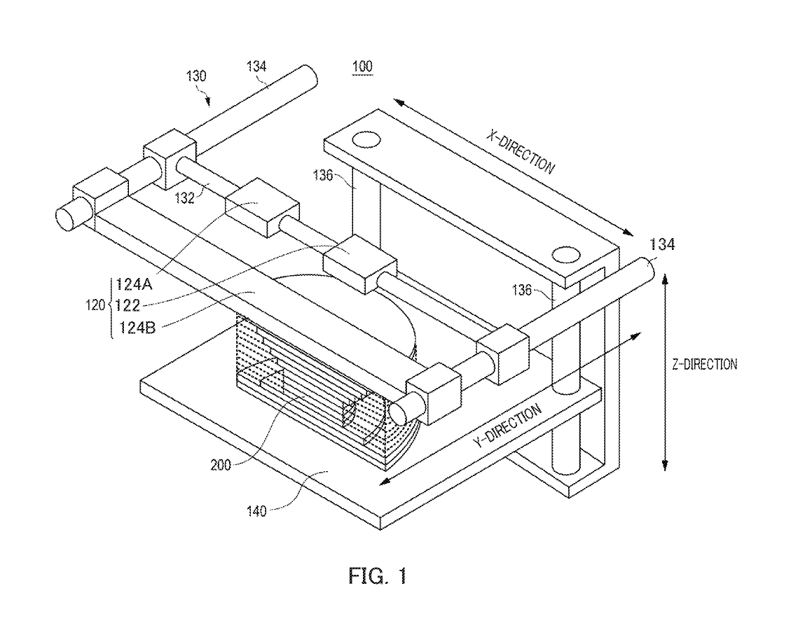

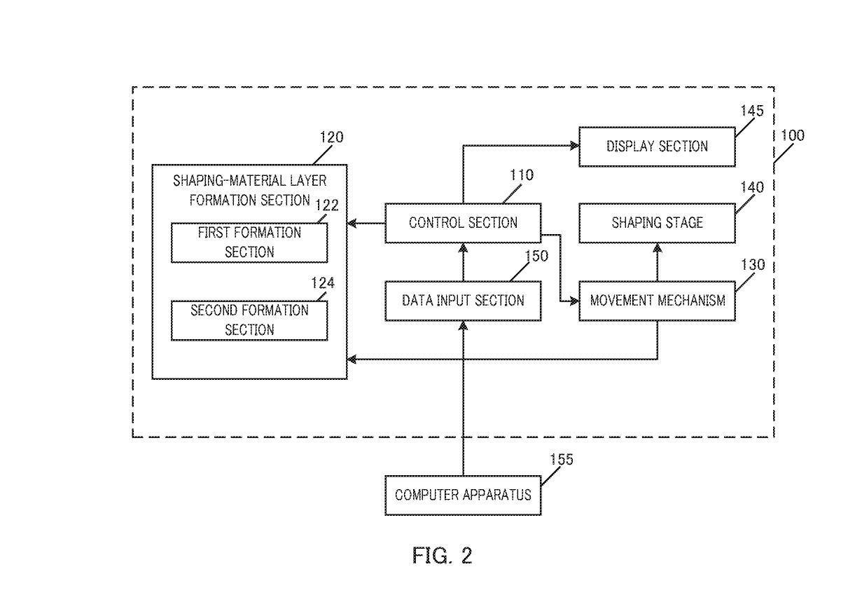

FIG. 1 schematically illustrates a configuration of three-dimensional shaping apparatus 100 according to the first embodiment. FIG. 2 illustrates a principal part of a control system of three-dimensional shaping apparatus 100 according to the first embodiment. Three-dimensional shaping apparatus 100 illustrated in FIGS. 1 and 2 shapes three-dimensional object 200 by sequentially stacking shaping material layers made of a first shaping material (also referred to as “model material”) on shaping stage 140. When the shaping object has an overhung portion (overhanging portion) for example, a second shaping material (also referred to as “supporting material”) is disposed in contact with the model material on the outside of the model material and the shaping material layers are sequentially stacked, to thereby support the overhung portion of the model material and cover the model material until the shaping of three-dimensional object 200 is completed. Here, an exemplary case where a photosetting resin is used as the shaping material will be described. The supporting material is removed by the user after the shaping of three-dimensional object 200 is completed. It is to be noted that the portion corresponding to the supporting material is illustrated with a broken line in FIG. 1 for convenience of description.

Three-dimensional shaping apparatus 100 includes control section 110, shaping-material layer formation section 120, movement mechanism 130, shaping stage 140, display section 145 and data input section 150. Three-dimensional shaping apparatus 100 is connected with computer apparatus 155.

Data input section 150 acquires 3D data (such as CAD data and design data) of a shaping object from computer apparatus 155, and outputs the data to control section 110. Computer apparatus 155 is configured to design the shaping object, or generate shaping data based on three-dimensional information obtained through measurement of a real object using a three-dimensional measuring apparatus. The CAD data and the design data may include color image information of a part of the surface of the shaping object or the entire surface of the shaping object and color image information of the interior of the shaping object, as well as the shape of the shaping object. It is to be noted that the method for acquiring 3D data is not particularly limited. 3D data may be acquired through short-range radio communication such as wired communication, radio communication, and Bluetooth (registered trademark), or may be acquired from a recording medium such as a universal serial bus (USB) memory. In addition, the 3D data may be acquired from a server that manages and stores the 3D data, or the like.

Control section 110 includes a computing section such as a central processing unit (CPU) or the like, and reconstructs data of each shaping material layer (hereinafter referred to as “slice data”) for shaping a three-dimensional object on the basis of 3D data output from data input section 150. In addition, during the shaping operation of three-dimensional object 200, control section 110 controls the entire operation of three-dimensional shaping apparatus 100. For example, control section 110 outputs to movement mechanism 130 mechanism control information for discharging the shaping material to a desired place, and outputs the slice data to shaping-material layer formation section 120. That is, control section 110 synchronizes and controls shaping-material layer formation section 120 and movement mechanism 130.

Display section 145 displays various information and messages which are required to be received by the user.

Shaping-material layer formation section 120 includes first formation section 122 and second formation section 124. Second formation section 124 includes discharging section 124A and curing section 124B as illustrated in FIG. 1. First formation section 122 and discharging section 124A respectively include casings 123 and 125 that operate as carriages which freely move in x-direction and y-direction orthogonal to each other in a horizontal plane. Curing section 124B includes casing 126 that operates as a carriage which moves in y-direction.

Shaping stage 140 is disposed below shaping-material layer formation section 120. On shaping stage 140, shaping material layers are formed and stacked by shaping-material layer formation section 120 so as to shape three-dimensional object 200.

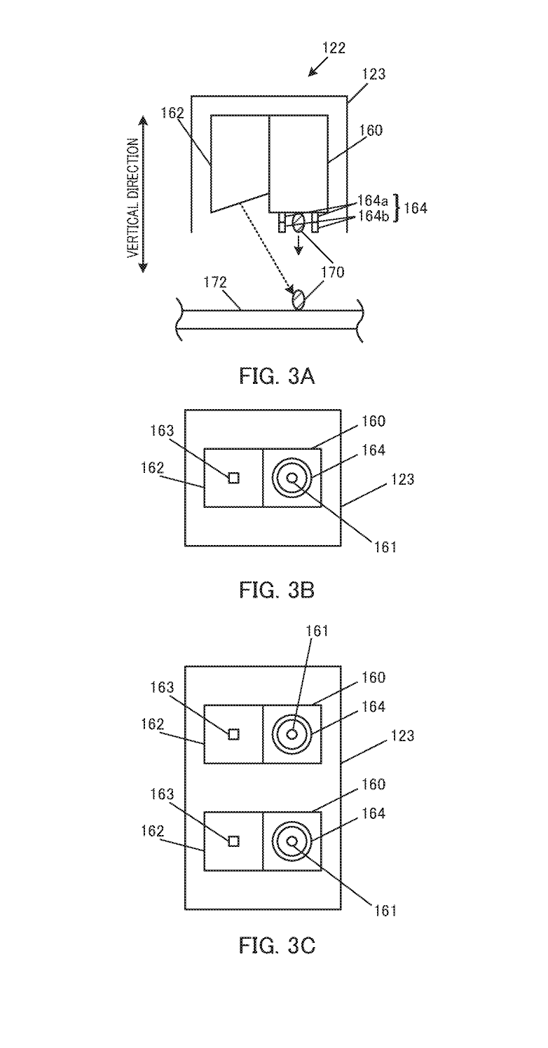

As illustrated in FIG. 3, first formation section 122 includes ink-jet discharging head 160 and light irradiation device 162 which are disposed in casing 123. Discharging head 160 includes discharging nozzle (first discharging nozzle) 161 that selectively discharges droplet 170 of the shaping material. In the present embodiment, clogging detection section 164 that detects clogging (that is, a situation where droplet 170 is not discharged from the discharging nozzle, or discharging is insufficient because of foreign matters adhering to the inside of the nozzle and the like) is provided in the proximity of an end portion of discharging nozzle 161. Clogging detection section 164 includes cylindrical electrode 164a that charges droplet 170d discharged from the discharging nozzle, and cylindrical dielectric electrode 164b through which charged droplet 170 passes. On the basis of results of measurement of an induced current which is generated at the time when charged droplet 170 passes through cylindrical dielectric electrode 164b, control section 110 detects clogging of the discharging nozzle (see, for example, Japanese Patent Application Laid-Open No. 59-120464). It is to be noted that the method of detecting clogging of the discharging nozzle disclosed in Japanese Patent Application Laid-Open No. 2005-35309 for example may be employed in which clogging of the discharging nozzle is detected by generating a light beam in a direction interesting with the discharging direction of the droplet and by checking whether discharged droplet has blocked the light beam. When a detection step of detecting clogging of discharging nozzle 161 prior to three-dimensional shaping is provided, wasteful consumption of the shaping material due to formation of insufficient shaping articles can be prevented.

Discharging head 160 discharges droplet 170 of the shaping material from the discharging nozzle toward shaping stage 140 while moving in x-direction and y-direction orthogonal to each other in a horizontal plane along an outline portion which is formed when a shaping material layer is formed. Here, the outline is a shape which can be visually recognized when a shaped three-dimensional object 200 is viewed from outside. In the above-mentioned manner, the outline of the shaping material layer is formed in a desired region on shaping stage 140. It is to be noted that discharging head 160 may discharge droplet 170 while moving around the outline of the shaping material layer one time, or may discharge droplet 170 while moving around the outline of the shaping material layer multiple times.

In the present embodiment, the nozzle diameter of discharging nozzle 161 of discharging head 160 is set to a small value to form the outline of the shaping material layer with a resolution higher than that of the inner portion of the outline (the region enclosed by the outline). Here, in the present example, the resolution is represented by the number of droplets which can be provided in a unit distance. Since the outline of the shaping material layer can be formed into a shape with a small number of (for example, one or several) droplets 170, the number of discharging nozzles 161 of discharging head 160 can be reduced. Therefore, even when discharging head 160 is provided with clogging detection sections 164 corresponding to the number of discharging nozzles 161, it is possible to suppress the cost and the device size of first formation section 122 to the minimum. Accordingly, even when clogging of the discharging nozzle is facilitated due to a decreased nozzle diameter of discharging nozzle 161, the clogging can be surely detected with clogging detection sections 164, and it is possible to take measures such as self-cleaning of the nozzle and notification to the user with a message on display section 145 indicating the occurrence of nozzle clogging.

Discharging head 160 stores the shaping material such that the shaping material is dischargeable. In the present embodiment, as discharging head 160, a discharging head which can discharge a shaping material having a viscosity of 5 to 15 [mP·s] is employed. As the shaping material, a photosetting material which is curable with irradiation of light having a specific wavelength is used. Examples of the photosetting material include ultraviolet curable resins, and it is possible to use radical polymerized ultraviolet curable resins such as acrylic acid ester and vinyl ether; and cation polymerized ultraviolet curable resins using a combination of an epoxy monomer, an epoxy oligomer, an oxetane monomer, an oxetane oligomer and the like, and acetophenone, benzophenone and the like as a reaction initiator according to the resin. The photosetting material can be stored in a dischargeable state by using a light blocking member, a filter and the like to block light having a specific wavelength capable of facilitating the curing. The shaping material is discharged onto shaping stage 140 from discharging head 160, thereby forming a shaping material layer. The shaping material layer is semi-cured by a curing process with light irradiation. Here, a semi-cured state is a state where the shaping material layer has been cured such that the layer has a viscosity enough to maintain the shape of the layer. From the viewpoint of sufficiently ensuring the adhesion property to the subsequently formed shaping material layer, it is preferable to keep a semi-cured state without completing the photopolymerization reaction at the time of curing of each shaping material layer such that the photopolymerization reaction is caused between the shaping material layer and the subsequently formed shaping material layer at the time of curing the subsequently formed shaping material layer.

In the case where the shaping object has an overhung portion (overhanging portion), or the case where the surface of three-dimensional object 200 is covered with another material for the purpose of protecting three-dimensional object 200, it is preferable to further provide a discharging head for discharging supporting material. For example, as illustrated in FIG. 3C, it is possible to employ a configuration in which a second discharging head and a second light irradiation device are provided in casing 123 of first formation section 122. In this case, discharging of a shaping material as a model material from the first discharging head and discharging of the shaping material as the supporting material from the second discharging head may be simultaneously performed, or the supporting material may be discharged from the second discharging head after discharging the model material corresponding to one layer from the first discharging head such that the supporting material is in contact with the discharged model material, or, the model material may be discharged from the first discharging head after discharging the supporting material corresponding to one layer from the second discharging head such that the model material is in contact with the discharged supporting material.

Light irradiation device 162 irradiates a droplet of the photosetting resin discharged to shaping stage 140 with light from light irradiation port 163 to perform a curing process (light irradiation process) and semi-cures the droplet. When the shaping material is an ultraviolet curing material, an UV laser irradiation device that emits an ultraviolet (UV) laser beam is used as light irradiation device 162. In the present embodiment, at a timing when droplet 170 of the shaping material discharged from discharging head 160 reaches shaping surface 172, control section 110 controls light irradiation device 162 to irradiate droplet 170 reaching shaping surface 172 with light (dotted arrow in FIG. 3). To be more specific, the dropping time of droplet 170 is measured in advance, and, on the basis of the estimated time period from the discharging of the shaping material to impinging on shaping surface 172, droplet 170 is irradiated with light simultaneously with the impinging or immediately after the impinging. Alternatively, the installation angle of light irradiation device 162 is adjusted such that a laser beam emitted from light irradiation port 163 reaches the impinging area of droplet 170 on shaping surface 172, and light is continuously emitted so as to include the timing at which droplet 170 reaches shaping surface 172. Here, shaping surface 172 is the surface of shaping stage 140 in the case where a first layer of the shaping material layers is formed, and is the surface of the Nth shaping material layer in the case where the N+1th shaping material layer is formed. By irradiating droplet 170 reaching shaping surface 172 with light at the timing when droplet 170 reaches shaping surface 172, droplet 170 can be cured before wet spreading of droplet 170 is caused on shaping surface 172, and thus the outline of the shaping material layer can be formed with high resolution. It is to be noted that light irradiation device 162 may emit the light only at the timing when droplet 170 discharged from discharging head 160 reaches shaping surface 172, or may continuously emit the light so as to include the timing when droplet 170 reaches shaping surface 172.

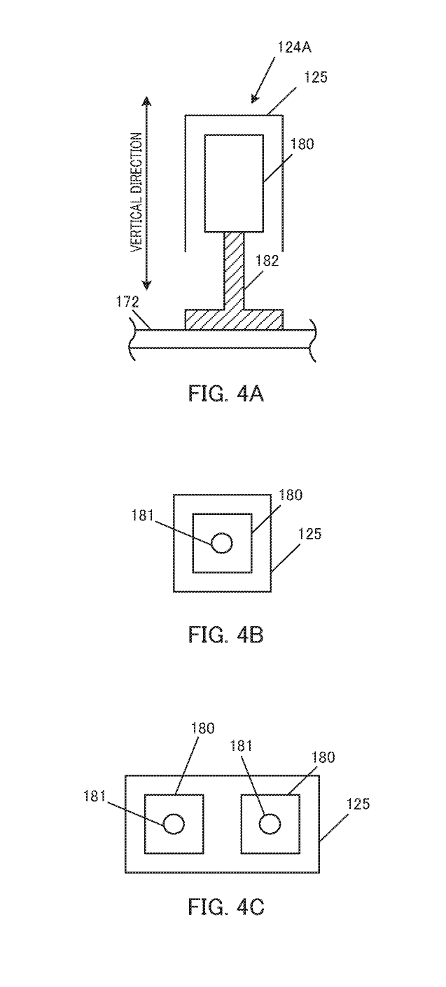

As illustrated in FIG. 4, discharging section 124A includes discharging device 180 that discharges shaping material 182 toward shaping surface 172 from discharging nozzle 181. Discharging device 180 is provided in casing 125. In the present embodiment, discharging device 180 is a dispenser capable of controlling the discharging rate of shaping material 182, and can control the discharging and stopping of shaping material 182. Discharging device 180 includes a discharging nozzle (second discharging nozzle) capable of continuously discharging shaping material 182. After first formation section 122 has started an operation of forming an outline of a shaping material layer, discharging device 180 discharges shaping material 182 to fill the inner portion of the outline and forms the inner portion under the control of control section 110. With this configuration, when discharging device 180 discharges shaping material 182, the outline of the shaping material layer formed by first formation section 122 serves as a wall, and it is thus possible to prevent shaping material 182 from leaking out of the outline. The discharging rate of shaping material 182 of discharging device 180 is set by obtaining the volume of the internal portion of the outline by multiplying the planar dimension of the inner portion of the outline of the shaping material layer formed by first formation section 122 and the height of the outline (that is, the thickness of one layer of the shaping material layer). In the present embodiment, the discharging rate of shaping material 182 is set to a value greater than the volume obtained by multiplying the planar dimension of the inner portion of the outline and the height of the outline to a degree that shaping material 182 does not leak from the wall of the outline. It is to be noted that, in the present embodiment, shaping material 182 is supplied so as to fill the inner portion of the outline, and therefore the inner portion of the outline can be considered to have no resolving property. Thus, naturally, first formation section 122 forms the outline with a resolution higher than that of second formation section 124, and second formation section 124 forms the inner portion of the outline with a resolution lower than that of first formation section 122.

It suffices that discharging device 180 discharges shaping material 182 so as to fill the inner portion of the outline of the shaping material layer (that is, high resolution is not required for formation of the inner portion of the outline), and therefore the nozzle diameter of discharging nozzle 181 of discharging device 180 is greater than that of discharging nozzle 161 of discharging head 160. With this configuration, clogging of discharging nozzle 181 of discharging device 180 can be prevented. In addition, discharging device 180 can discharge a droplet having a size greater than that of the droplet discharged from discharging head 160. That is, discharging device 180 performs shaping with a resolution lower than that of discharging head 160 and thus can form the inner portion of the outline of the shaping material layer with a speed higher than the formation speed of discharging head 160. That is, discharging device 180 can complete the application of shaping material 182 to an area in a shorter time in comparison with discharging head 160.

While the shaping material used by discharging device 180 may be the same as the shaping material used by discharging head 160, it is also possible to use different shaping materials having different viscosities or the like in accordance with light irradiation device 194 for the light irradiation process. In addition, it is possible to change the light polymerization initiator used for the shaping material used in discharging device 180 in accordance with light irradiation device 194.

While, in the case where the supporting material is required, the shaping material as the supporting material may be discharged from the above-described second discharging nozzle, it is also possible to employ a configuration in which a second discharging device having a discharging port having a large diameter as with discharging device (first discharging device) 180 is provided at discharging section 124A of second formation section 124 for the purpose of avoiding decrease of the shaping speed as illustrated in FIG. 4C. In this case, the supporting material may be discharged from the second discharging device such that the supporting material is in contact with the discharged model material after discharging of the model material for one layer from first discharging device 180 is completed, or the model material may be discharged from the first discharging device such that the model material is in contact with the discharged supporting material after discharging of the supporting material for one layer from the second discharging device is completed.

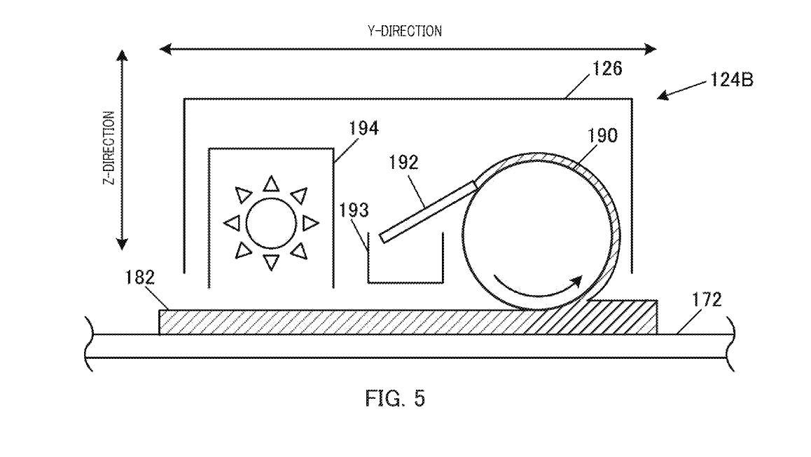

As illustrated in FIG. 5, curing section 124B includes, in casing 126, levelling roller 190 as a planarizing section that levels shaping material 182, scraping member 192, collecting member 193 for scraped shaping material 182 and light irradiation device 194 as a curing section that cures shaping material 182. Levelling roller 190, scraping member 192 and light irradiation device 194 are disposed in curing section 124B in this order from the near side in FIG. 1.

Levelling roller 190 can be driven into rotation under the control of control section 110, and levelling roller 190 makes contact with the surface of shaping material 182 discharged by discharging device 180 to planarize the surface of shaping material 182. Consequently, a shaping material layer (the outline and the inner portion of the outline) having a uniform thickness is formed. As a result of planarization of the surface of the shaping material layer, the next shaping material layer can be precisely formed and stacked, and thus highly precise three-dimensional object 200 can be shaped. It is to be noted that the leveling member for planarizing the surface of shaping material 182 is not limited to levelling roller 190, and a blade or the like may be used for example.

Scraping member 192 is a blade provided in the proximity of levelling roller 190. Scraping member 192 scrapes the shaping material attached on the surface of levelling roller 190. Shaping material 182 scraped by scraping member 192 may be supplied to discharging head 160 (first formation section 122) and discharging device 180 (discharging section 124A) and reused, or may be sent to a waste tank.

Light irradiation device 194 performs a curing process (light irradiation process) on shaping material 182 composed of a photosetting resin discharged by discharging device 180, and semi-cures shaping material 182. When the shaping material is an ultraviolet curing material, a UV lamp (in the present embodiment, a high-pressure mercury lamp) that emits an ultraviolet ray (UV) is used as light irradiation device 194. It is to be noted that instead of a high-pressure mercury lamp, a low-pressure mercury lamp, an intermediate pressure mercury lamp, an ultra-high pressure mercury lamp, a carbon-arc lamp, a metal halide lamp, a xenon lamp, an ultraviolet LED lamp or the like may be used as light irradiation device 194.

Movement mechanism 130 three-dimensionally changes the relative position of first formation section 122 and discharging section 124A, and shaping stage 140. In addition, movement mechanism 130 two-dimensionally changes the relative position of curing section 124B and shaping stage 140. To be more specific, movement mechanism 130 includes x-direction guide 132 that is engaged with first formation section 122 and discharging section 124A, y-direction guide 134 that guides x-direction guide 132 and curing section 124B in y-direction, and z-direction guide 136 that guides shaping stage 140 in z-direction which is a vertical direction as illustrated in FIG. 1. Further, movement mechanism 130 includes a drive mechanism composed of a motor, a drive reel and the like which are not illustrated.

Movement mechanism 130 drives a motor and a drive mechanism not illustrated in accordance with mechanism control information output from control section 110, and freely moves first formation section 122 and discharging section 124A in x-direction and y-direction (see FIG. 1). It is to be noted that movement mechanism 130 may have a configuration in which the positions of first formation section 122 and discharging section 124A are fixed and shaping stage 140 is moved in x-direction and y-direction, or a configuration in which first formation section 122 and discharging section 124A, and shaping stage 140 are moved. Alternatively, movement mechanism 130 may have a configuration provided with two x-direction guides 132 each of which is engaged with first formation section 122 and discharging section 124A.

In addition, movement mechanism 130 freely moves curing section 124B in y-direction in accordance with mechanism control information output from control section 110 (see FIG. 1). It is to be noted that movement mechanism 130 may have a configuration in which the position of curing section 124B is fixed and shaping stage 140 is moved in y-direction, or a configuration in which both of curing section 124B and shaping stage 140 are moved.

In the present embodiment, for the purpose of freely moving first formation section 122 in x-direction and y-direction, discharging section 124A and curing section 124B are moved as necessary such that the movement of first formation section 122 is not interfered. In addition, for the purpose of freely moving discharging section 124A in x-direction and y-direction, first formation section 122 and curing section 124B are moved as necessary such that the movement of discharging section 124A is not interfered. In addition, for the purpose of freely moving curing section 124B in y-direction, x-direction guide 132 is moved in y-direction as necessary such that the movement of curing section 124B is not interfered. It is also possible to preliminarily set evacuation positions of first formation section 122, discharging section 124A and curing section 124B where first formation section 122, discharging section 124A and curing section 124B do not interfere with each other, so as move first formation section 122, discharging section 124A and curing section 124B to the evacuation positions.

In addition, movement mechanism 130 adjusts the interval between shaping-material layer formation section 120 and three-dimensional object 200 by moving shaping stage 140 downward in z-direction in accordance with mechanism control information output from control section 110 (see FIG. 1). That is, shaping stage 140 can be moved by movement mechanism 130 in z-direction, and is moved downward in z-direction by a distance (lamination pitch) corresponding to the thickness of one shaping material layer after Nth (N is a positive integer) shaping material layer is formed on shaping stage 140. Then, after N+1th shaping material layer is formed on shaping stage 140, shaping stage 140 is again moved downward in z-direction by the lamination pitch. It is to be noted that movement mechanism 130 may fix the position of shaping stage 140 in z-direction and move shaping-material layer formation section 120 upward in z-direction, or may move both of shaping-material layer formation section 120 and shaping stage 140.

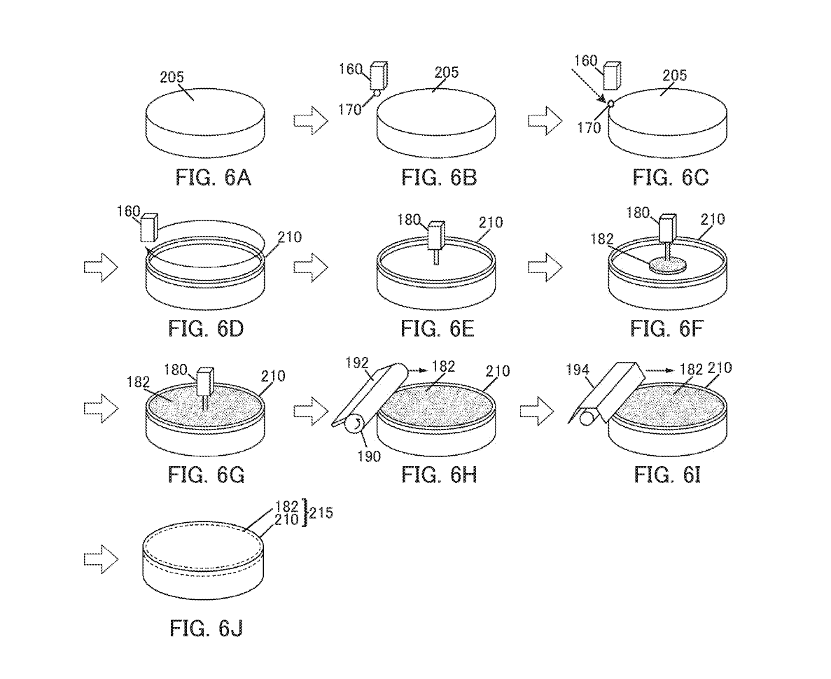

FIGS. 6A to 6J schematically illustrate an operation of shaping-material layer formation section 120 for forming one shaping material layer. To be more specific, FIGS. 6A to 6J illustrate an operation of forming N+1th shaping material layer 215 on Nth shaping material layer 205. FIGS. 6A to 6J illustrate an exemplary case where a columnar shaping article is formed.

FIG. 6A illustrates a state after Nth shaping material layer 205 is formed by shaping-material layer formation section 120. At this time, shaping material layer 205 has been semi-cured through a curing process of light irradiation device 194 of curing section 124B.

FIG. 6B illustrates a state where discharging head 160 of first formation section 122 moves to a position over the outline of N+1th shaping material layer 215, and discharges droplet 170 of the shaping material from discharging nozzle.

FIG. 6C illustrates a state where light irradiation device 162 of first formation section 122 irradiates droplet 170 reaching a shaping surface (in the example illustrated in FIG. 6C, the surface of Nth shaping material layer 205) with light (dotted arrow in FIG. 6C) at the timing when droplet 170 of the shaping material discharged from discharging head 160 reaches the shaping surface.

FIG. 6D illustrates a state where discharging head 160 discharges droplet 170 of the shaping material while moving along the outline (annular shape) of N+1th shaping material layer 215. Although not shown in the drawing, light irradiation device 162 irradiates droplet 170 of the shaping material discharged from discharging head 160 with light while moving as with discharging head 160. As a result, on Nth shaping material layer 205, outline 210 of N+1th shaping material layer 215 is formed in a semi-cured state. In this manner, development of curing is started immediately after droplet 170 reaches the shaping surface, and thus outline 210 can be easily maintained in a desired shape. In addition, since it suffices to develop the curing only until a hardness enough to maintain the shape is obtained, the limitation on the performance required for light irradiation device 162 is reduced.

FIG. 6E illustrates a state where discharging device 180 of second formation section 124 has moved to a certain position in the inner portion of outline 210 (for example, a center of the inner portion of outline 210) to supply shaping material 182. FIG. 6 illustrates an exemplary case where discharging device 180 discharges shaping material 182 while remaining at a center of the inner portion of outline 210, but discharging device 180 may discharge shaping material 182 while appropriately moving in the inner portion of outline.

FIG. 6F illustrates a state where shaping material 182 discharged from discharging device 180 fills the inner portion of outline 210 little by little. FIG. 6G illustrates a state where the inner portion of outline 210 is completely filled with shaping material 182 discharged from discharging device 180 in an uncured state. Here, by forming outline 210 in advance, subsequently supplied uncured shaping material 182 can be surely prevented from leaking out of outline 210, and a shaping article whose surface shape is correctly reproduced can be obtained.

FIG. 6H illustrates a state where levelling roller 190 of curing section 124B makes contact with the surface of shaping material 182 discharged by discharging device 180 while moving in the arrow direction to planarize the irregularity on the surface of shaping material 182.

FIG. 6I illustrates a state where light irradiation device 194 of curing section 124B performs a light irradiation process on shaping material 182 discharged by discharging device 180 while moving in the arrow direction to develop the curing. It is to be noted that, for convenience of description of the process of each step, levelling roller 190 and light irradiation device 194 are separated from each other in FIG. 6.

FIG. 6J illustrates a state where N+1th shaping material layer 215 composed of outline 210 and shaping material 182 (the inner portion of outline 210) has been formed through a light irradiation process performed by light irradiation device 194 on the entirety of shaping material 182 discharged by discharging device 180. In view of development of the curing of the entire shaping material at one time with the irradiation of light irradiation device 194, the light wavelength range of light irradiation device 194 is preferably set to a value at which the shaping materials of outline 210 and the inner portion are both cured.

As has been described in detail, in the first embodiment, three-dimensional shaping apparatus 100 includes first formation section 122 that forms outline 210 of the shaping material layer with a first resolution and a second formation section (discharging section 124A and curing section 124B) that forms the inner portion of outline 210 with a second resolution lower than the first resolution by discharging a shaping material toward shaping stage 140.

According to the first embodiment with the above-mentioned configuration, outline 210 of the shaping material layer which is related to the appearance of three-dimensional object 200 and is therefore required to be formed with a high resolution is formed with a resolution higher than that of the inner portion of outline 210, whereas the inner portion of outline 210 which is not related to the appearance and therefore is not required to be formed with a high resolution is formed with a formation speed lower than that of outline 210. With this configuration, the resolution of the shaping material layer can be increased without reducing the formation speed of the shaping material layer, and in turn the resolution of three-dimensional object 200 can be increased without reducing the shaping speed of three-dimensional object 200.

While a shaping material having a photosetting property is employed as the shaping material used for the shaping of three-dimensional object 200 in the above-mentioned embodiment, the present invention is not limited to this. For example, it is also possible to adopt a configuration using a thermosetting material as the shaping material in which a heating section that generates heat with a resistance heater or the like heats the shaping material to perform a curing process. The reason for this is that, also when a thermosetting material is used for the shaping material, the problem mentioned in “Technical Problem,” that is, the problem that the approach for increasing the resolution of three-dimensional object 200 reduces the shaping speed of the three-dimensional object 200. When a thermosetting material is used for the shaping material, a heat polymerization initiator is used in place of the light polymerization initiator, and curing section 124B is provided with a heating section having a heater and the like in place of light irradiation device 194.

While the inner portion of outline 210 is formed after the operation of forming outline 210 of shaping material layer 215 is started in the above-mentioned embodiment, the present invention is not limited to this. For example, outline 210 of shaping material layer 215 may be formed after the operation of forming the inner portion of outline 210 is started. In addition, the operation of forming outline 210 of shaping material layer 215 and the operation of forming the inner portion of outline 210 may be simultaneously performed. In this case, it is preferable to start the operation of forming the inner portion after outline 210 is formed to a certain degree and to complete the formation of outline 210 before the supply of the shaping material to the internal portion is completed.

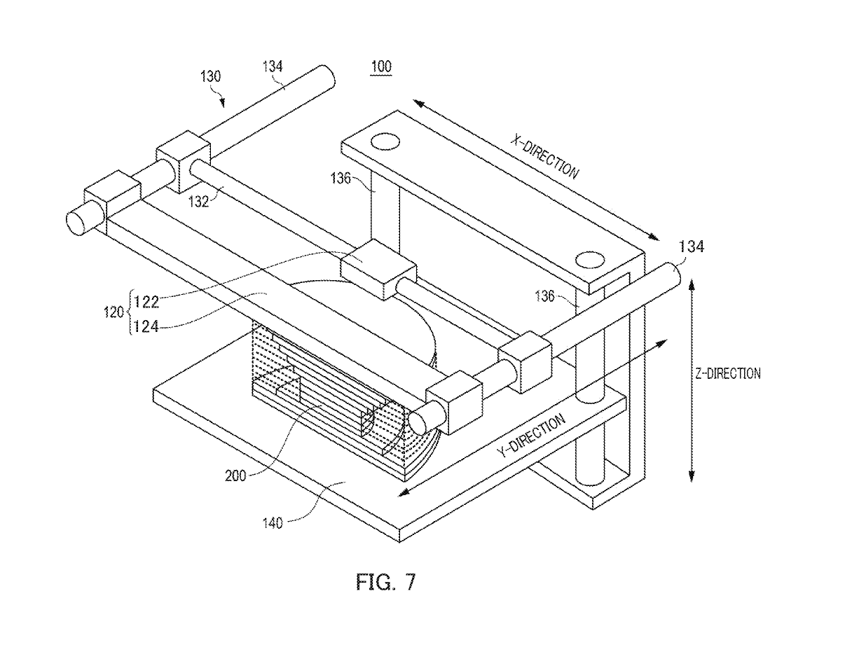

In the following, a second embodiment will be described in detail with reference to the accompanying drawings. FIG. 7 schematically illustrates a configuration of three-dimensional shaping apparatus 100 according to the second embodiment. As illustrated in FIG. 7, shaping-material layer formation section 120 includes second formation section 124 in place of discharging section 124A and curing section 124B of FIG. 1. It is to be noted that the same components as those of the first embodiment are denoted with the same reference numerals, and the description thereof will be omitted.

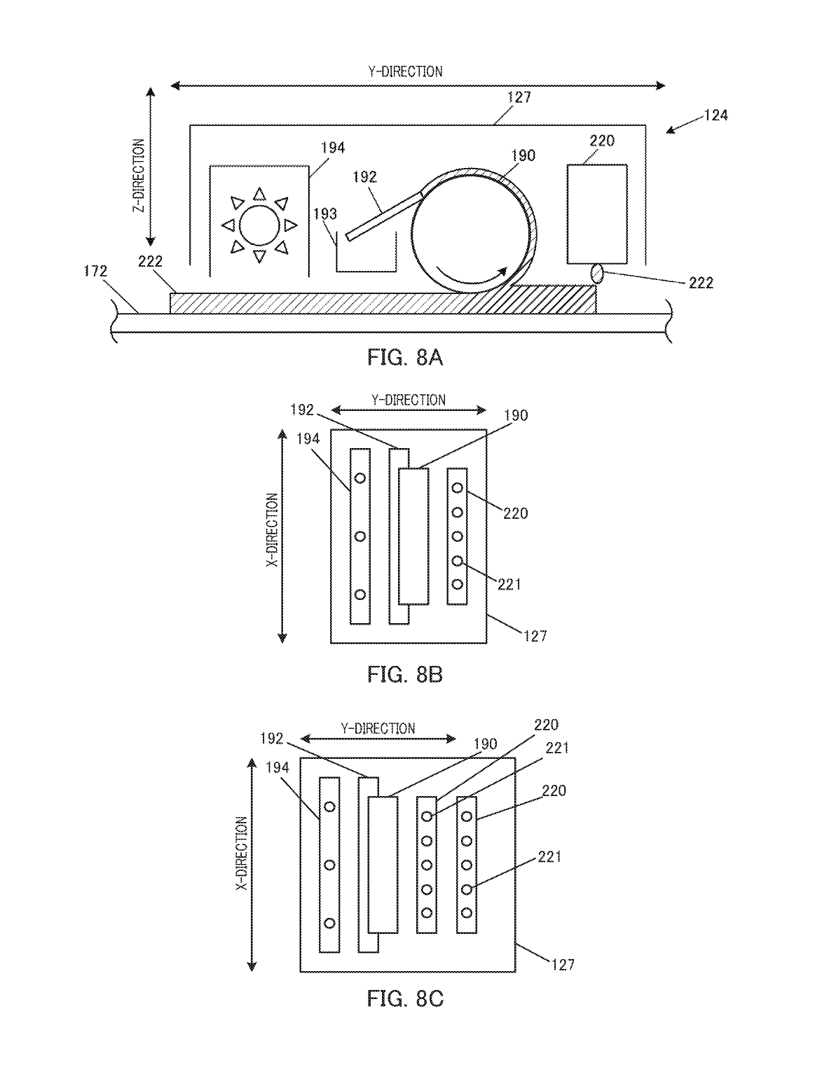

As illustrated in FIGS. 8A to 8C, second formation section 124 includes, in casing 127, ink-jet discharging head 220 in addition to levelling roller 190, scraping member 192, collecting member 193 and light irradiation device 194 of FIG. 5. Discharging head 220, levelling roller 190, scraping member 192 and light irradiation device 194 are disposed in second formation section 124 in this order from the near side of FIG. 7.

As illustrated in FIG. 8B, a plurality of discharging nozzles are arranged in line in a longitudinal direction (x-direction). As this discharging head 220, a conventionally used and publicly known discharging head for image formation is used. As long as the discharging nozzles are arranged in line, the discharging nozzles may be linearly disposed side by side, or may be arranged side by side in a zigzag form in line as a whole.

Discharging head 220 selectively discharges droplet 222 of the shaping material in parallel toward shaping stage 140 from a plurality of discharging nozzles while moving in a sub scanning direction orthogonal to the longitudinal direction. After first formation section 122 has started an operation of forming an outline of the shaping material layer, discharging head 220 discharges droplet 222 to fill the inner portion of the outline to form the inner portion under the control of control section 110.

It suffices that discharging head 220 discharges droplet 222 to fill the inner portion of the outline of the shaping material layer (that is, high resolution is not required for formation of the inner portion of the outline), the nozzle diameter of each discharging nozzle 221 of discharging head 220 is greater than that of the discharging nozzle of discharging head 160. Thus, clogging of discharging nozzle 221 of discharging head 220 can be prevented. In addition, discharging head 220 can discharge a droplet larger than the droplet discharged from discharging head 160. That is, discharging head 220 shapes the inner portion of the outline with a resolution lower than that of the outline, and thus can form the inner portion of the outline of the shaping material layer with a formation speed higher than that of discharging head 160. That is, discharging device 220 can complete the application of the shaping material to an area in a shorter time in comparison with discharging head 160.

When the supporting material is required, it is also possible to adopt a configuration illustrated in FIG. 8C in which second formation section 124 is provided with a second discharging head having a discharging port with a large diameter as with the discharging head (first discharging head) 220. In this case, the supporting material may be discharged from the second discharging device such that the supporting material is in contact with the discharged model material after discharging of the model material for one layer from first discharging head 220 is completed, or the model material may be discharged from first discharging head 220 such that the model material is in contact with the discharged supporting material after discharging of the supporting material for one layer from second discharging head 220 is completed. In addition, the shaping materials (the model material and the supporting material) may be respectively discharged from first and second discharging heads 220 in parallel.

Levelling roller 190 makes contact with the surface of droplet 222 discharged by discharging head 220 to planarize the surface of droplet 222. As a result, a shaping material layer (the outline and the inner portion of the outline) having a uniform layer thickness is formed. Scraping member 192 is a blade provided in the proximity of levelling roller 190 and scrapes the shaping material attached on the surface of levelling roller 190. Light irradiation device 194 performs a curing process (light irradiation process) on droplet 222 of the photosetting resin discharged by discharging head 220, and semi-cures droplet 222.

Movement mechanism 130 two-dimensionally changes the relative position of second formation section 124 and shaping stage 140. To be more specific, movement mechanism 130 includes x-direction guide 132 that is engaged with first formation section 122, y-direction guide 134 that guides x-direction guide 132 and second formation section 124 in y-direction, and z-direction guide 136 that guides shaping stage 140 in z-direction as illustrated in FIG. 7. Further, movement mechanism 130 includes a drive mechanism composed of a motor, a drive reel and the like which are not illustrated.

Movement mechanism 130 freely moves second formation section 124 in y-direction in accordance with mechanism control information output from control section 110 (see FIG. 7). It is to be noted that movement mechanism 130 may have a configuration in which the position of second formation section 124 is fixed and shaping stage 140 is moved in y-direction, or a configuration in which second formation section 124 and shaping stage 140 are moved.

In the present embodiment, for the purpose of freely moving first formation section 122 in x-direction and y-direction, second formation section 124 is moved as necessary in y-direction such that the movement of first formation section 122 is not interfered. In addition, for the purpose of freely moving second formation section 124 in y-direction, x-direction guide 132 is moved in y-direction as necessary such that the movement of second formation section 124 is not interfered. It is also possible to preliminarily set evacuation positions of first formation section 122 and second formation section 124 where first formation section 122 and second formation section 124 do not interfere with each other, so as to move first formation section 122 and second formation section 124 to the evacuation positions.

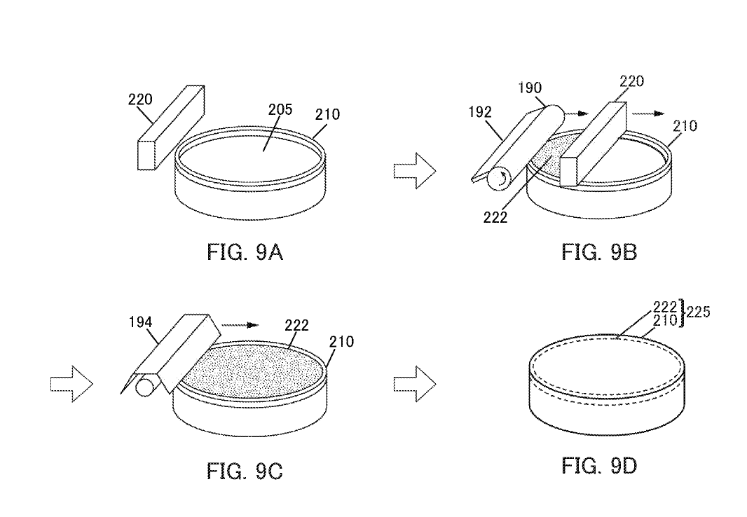

FIGS. 9A to 9D schematically illustrate operations of second formation section 124 for forming an inner portion of an outline of the shaping material layer. To be more specific, FIGS. 9A to 9D illustrate an operation of forming N+1th shaping material layer 225 on Nth shaping material layer 205.

FIG. 9A illustrates a state where outline 210 of N+1th shaping material layer 225 has been formed in a semi-cured state on Nth shaping material layer 205. Discharging head 220 of second formation section 124 moves to a position near outline 210 of N+1th shaping material layer 225.

FIG. 9B illustrates a state where discharging head 220 moves across the inner portion of outline 210 in the arrow direction, and discharges droplet 222 of the shaping material. Subsequent to the operation of discharging head 220 for discharging droplet 222, levelling roller 190 makes contact with the surface of droplet 222 discharged by discharging head 220 while moving in the arrow direction to planarize the irregularity of the surface of droplet 222.

FIG. 9C illustrates a state where light irradiation device 194 performs a light irradiation process on droplet 222 discharged by discharging head 220 while moving in the arrow direction to develop the curing. It is to be noted that, for convenience of description of the process of each step, levelling roller 190 and light irradiation device 194 are separated from each other in FIG. 9.

FIG. 9D illustrates a state where light source 194 performs a light irradiation process on the entirety of droplet 222 discharged by discharging head 220 to form N+1th shaping material layer 225 composed of droplet 222 (the inner portion of outline 210) and outline 210 in a semi-cured state.

As described above, in the second embodiment, second formation section 124 includes discharging head 220, levelling roller 190, scraping member 192 and light irradiation device 194, and simultaneously performs an operation of forming the inner portion of the outline of the shaping material layer (droplet 222), an operation of planarizing the surface of droplet 222 and an operation of curing droplet 222 while moving in y-direction. Therefore, in comparison with the first embodiment, the operation of shaping-material layer formation section 120 can be simplified, and the formation speed for one shaping material layer can be increased.

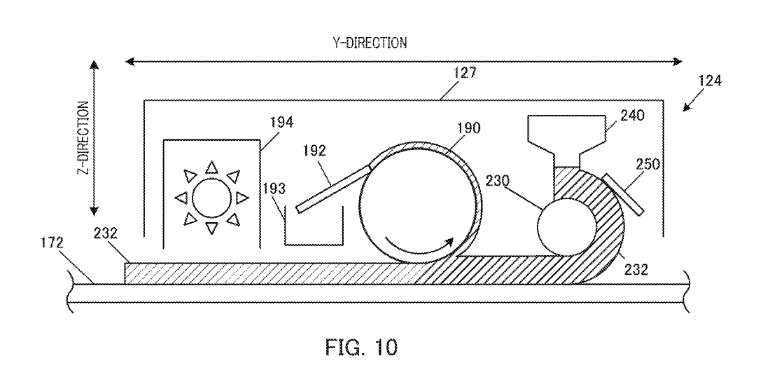

In the following, a third embodiment will be described in detail with reference to the accompanying drawings. FIG. 10 illustrates a configuration of second formation section 124 according to the third embodiment. As illustrated in FIG. 10, second formation section 124 includes, in place of discharging head 220 of FIG. 8, application roller 230, dispenser 240 that supplies a shaping material toward application roller 230, and blade 250a that sets the thickness of the shaping material supplied to application roller 230 to a certain thickness. It is to be noted that the same components as those of the second embodiment are denoted with the same reference numerals, and the description thereof will be omitted.

Application roller 230 can be driven into rotation under the control of control section 110, and applies droplet 232 (shaping material) formed on the surface of application roller 230 to shaping stage 140 while moving in y-direction orthogonal to the longitudinal direction. After the operation of first formation section 122 for forming an outline of the shaping material layer is started, application roller 230 applies droplet 232 to the inner portion of the outline to fill the inner portion, thereby forming the inner portion under the control of control section 110. The thickness of droplet 232 formed on the surface of application roller 230 is greater than the thickness of the outline formed by first formation section 122. With this configuration, at the time of application of droplet 232, application roller 230 does not make contact with the outline of the shaping material layer, and droplet 232 formed on the surface of application roller 230 makes contact with the inner portion of the outline of the shaping material layer.

Here, in view of preventing droplet 232 from adhering to the outline of the shaping material layer at the time when droplet 232 formed on the surface of application roller 230 makes contact with the outline, it is preferable to perform a process for providing ink repellency to the surface of the outline.

Levelling roller 190 makes contact with the surface of droplet 232 applied by application roller 230 to planarize the surface of droplet 232. As a result, a shaping material layer (the outline and the inner portion of the outline) having a uniform layer thickness is formed. Scraping member 192 is a blade provided at a position near levelling roller 190 and scrapes the shaping material attached on the surface of levelling roller 190. Light irradiation device 194 performs a curing process (light irradiation process) on droplet 232 of the photosetting resin applied by application roller 230 to semi-cure droplet 232.

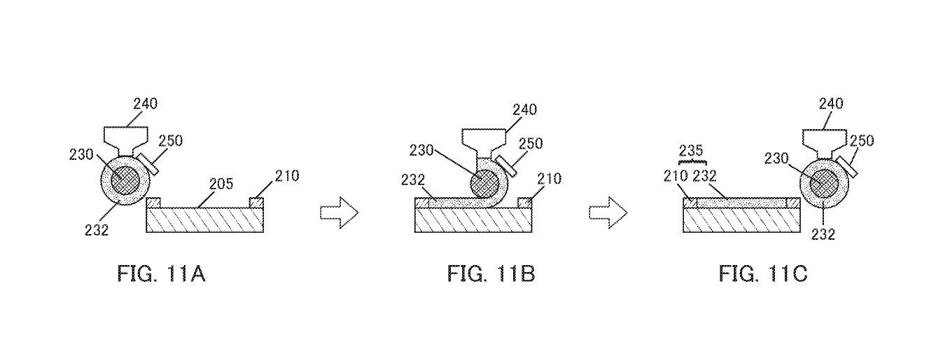

FIGS. 11A to 11C schematically illustrate an operation of application roller 230 for forming the inner portion of the outline of the shaping material layer. To be more specific, FIGS. 11A to 11C illustrate an operation of forming N+1th shaping material layer 235 on Nth shaping material layer 205.

FIG. 11A illustrates a state where outline 210 of N+1th shaping material layer 235 has been formed in a semi-cured state on Nth shaping material layer 205. Application roller 230 of second formation section 124 moves to a position near outline 210 of N+1th shaping material layer 235.

FIG. 11B illustrates a state where application roller 230 moves across the inner portion of outline 210 and applies droplet 232 of the shaping material to the inner portion. Although not shown in the drawing, subsequent to the operation of applying droplet 232 to application roller 230, levelling roller 190 planarizes the irregularity on the surface of droplet 232, and light irradiation device 194 performs a light irradiation process on droplet 232 to semi-cure droplet 232.

FIG. 11C illustrates a state where N+1th shaping material layer 235 composed of droplet 232 (the inner portion of outline 210) and outline 210 in a semi-cured state has been formed through a light irradiation process performed by light irradiation device 194 on the entirety of droplet 232 discharged by application roller 230.

As described above, in the third embodiment, application roller 230 applies droplet 232 to the inner portion of the outline of the shaping material layer to fill the inner portion, thereby forming the inner portion. The application amount per unit time of application roller 230 is greater than the discharging rate per unit time of discharging head 220 of the second embodiment. Therefore, in comparison with the second embodiment, the formation speed for the inner portion of the outline of the shaping material layer can be increased, and in turn the formation speed for one shaping material layer can be increased. It is to be noted that, in the present embodiment, application roller 230 applies the shaping material to the inner portion of the outline at one time, and therefore the inner portion of the outline can be considered to have no resolving property. Thus, naturally, first formation section 122 forms the outline with a resolution higher than that of second formation section 124, and second formation section 124 forms the inner portion of the outline with a resolution lower than that of first formation section 122.

Preferably, in the first and second embodiments, the shaping material discharged from discharging head 160 is a shaping material having a sol-gel phase transition temperature. For example, it is preferable to use a shaping material having a sol-gel phase transition temperature higher than normal temperature (natural temperature without heating or cooling). Here, the sol-gel phase transition temperature is a temperature at which the value of the viscosity of the liquid exceeds 500 [mP·s] when the temperature of a liquid in sol state of is being reduced. When the value of the viscosity exceeds 500 [mP·s], a droplet having a size of tens of micrometers do not flow as long as an external force is not applied thereto. That is, the shape of the droplet can be kept as it is.

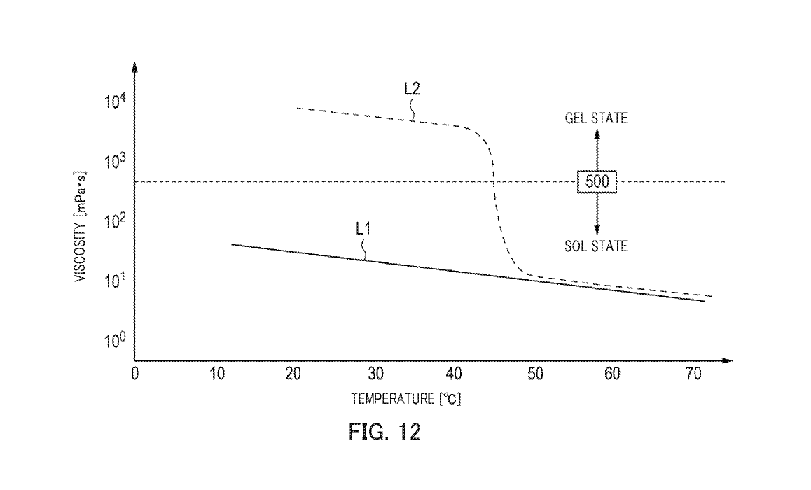

FIG. 12 shows the temperature dependency of the viscosity of a shaping material having a sol-gel phase transition temperature. The value of the viscosity was obtained using rheometer MCR300 (available from Anton Paar GmbH) under a condition of a shear rate of 1000 [1/s]. In FIG. 12, L1 indicates the temperature dependency of the viscosity of a shaping material which does not have a sol-gel phase transition temperature. L2 indicates the temperature dependency of the viscosity of a shaping material which has a sol-gel phase transition temperature higher than normal temperature.

As illustrated in FIG. 12, the viscosity of the shaping material (L1) which does not have a sol-gel phase transition temperature linearly increases as the temperature is reduced, but does not exceed 500 [mP·s] even when the temperature is reduced to approximately 10[° C.], and phase transition from sol state to gel state does not occur. Meanwhile, the value of the viscosity of shaping material (L2) which has a sol-gel phase transition temperature higher than normal temperature exceeds 500 [mP·s] at approximately 45[° C.], and phase transition from sol state to gel state occurs.

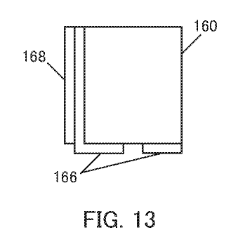

In the first and second embodiments, discharging head 160 can discharge the shaping material within a viscosity range of 5 to 15 [mP·s]. Therefore, when a shaping material having a sol-gel phase transition temperature higher than normal temperature is used, the shaping material in sol state can be discharged by heating discharging head 160 to 70 to 80[° C.], and the impinging droplet thus discharged is instantly naturally cooled to 45[° C.], thus causing phase transition from sol state to gel state. Consequently, it is possible to prevent wet spreading on shaping surface 172 from occurring at the timing when droplet 170 discharged from discharging head 160 reaches shaping surface 172. That is, it is not necessary to irradiate droplet 170 reaching shaping surface 172 with light from light irradiation device 162 to cure droplet 170 at the timing when droplet 170 reaches shaping surface 172, and curing can be performed by emitting light from light irradiation device 194. As described, when a shaping material having a sol-gel phase transition temperature higher than normal temperature is used, the shaping material stored in discharging head 160 is required to be in sol state, and therefore it is preferable to provide a heating section that heats discharging head 160 (see FIG. 13).

In the configuration illustrated in FIG. 13, heater 168 is provided at the outer periphery of discharging head 160 with heat transfer member 166 therebetween. The output of heater 168 is controlled by control section 110. Heater 168 is connected with a heater power source not illustrated. Heat transfer member 166 is extended to the discharging nozzle surface of discharging head 160. That is, heat transfer member 166 efficiently transfers the heat of heater 168 to the channel of the shaping material discharged from discharging head 160, and, to the discharging nozzle surface and its surroundings, thereby heating the air around the discharging nozzle surface. Control section 110 controls the output of heater 168 so as to heat discharging head 160 to a temperature equal to or higher than the sol-gel phase transition temperature. With this configuration, even a shaping material having a sol-gel phase transition temperature higher than normal temperature can be discharged from discharging head 160.

It should be understood by those skilled in the art that various modifications, combinations, sub-combinations and alterations may occur depending on design requirements and other factors in so far as they are within the scope of the appended claims or the equivalents thereof. While the invention made by the present inventor has been specifically described based on the preferred embodiments, it is not intended to limit the present invention to the above-mentioned preferred embodiments but the present invention may be further modified within the scope and spirit of the invention defined by the appended claims.

This application is entitled to and claims the benefit of Japanese Patent Application No. 2013-208327 filed on Oct. 3, 2013, the disclosure of which including the specification, drawings and abstract is incorporated herein by reference in its entirety.

### REFERENCE SIGNS LIST

100 Three-dimensional shaping apparatus
110 Control section
120 Shaping-material layer formation section
122 First formation section
124 Second formation section
124A Discharging section
124B Curing section
130 Movement mechanism
132 x-direction guide
134 y-direction guide
136 z-direction guide
140 Shaping stage
150 Data input section
155 Computer apparatus
160, 220 Discharging head
162, 194 Light irradiation device
164 Clogging detection section
166 Heat transfer member
168 Heater
170, 182, 222, 232 Droplet (Shaping material)
172 Shaping surface
180 Discharging device
190 Levelling roller
192 Scraping member
200 Three-dimensional object
205, 215, 225, 235 Shaping material layer
210 Outline
230 Application roller

1. A three-dimensional shaping apparatus comprising:
a shaping stage on which a shaping material layer made of a shaping material is formed;
a first formation section including a first discharging nozzle configured to discharge a first shaping material, the first formation section being configured to discharge the first shaping material from the first discharging nozzle toward the shaping stage to form an outline of the shaping material layer with a first resolution;
a heating section configured to heat the first shaping material;
a second formation section configured to supply a second shaping material to the shaping stage to form an inner portion of the outline with a second resolution lower than the first resolution; and
a light irradiation device which irradiates a light on the shaping material provided on the shaping stage, wherein
the first and second shaping materials have a photosetting property;
the first shaping material has a sol-gel phase transition temperature which is higher than normal temperature;
the first forming section is able to discharge the first shaping material in a sol phase which is heated by the heating section; and
the first and second shaping materials supplied from the first formation section and the second formation section onto the shaping stage are cured by irradiating the light thereon, and a plurality of shaping material layers are formed and stacked on one another to shape a three-dimensional object.

2. The three-dimensional shaping apparatus according to claim 1, wherein the second formation section forms the inner portion of the outline after a formation operation of the first formation section is started.

3. The three-dimensional shaping apparatus according to claim 1, wherein the second formation section includes a second discharging nozzle configured to discharge the second shaping material, and discharges a droplet having a size greater than a size of a droplet of the first shaping material discharged from the first discharging nozzle.

4. The three-dimensional shaping apparatus according to claim 3, wherein the second discharging nozzle has a nozzle diameter greater than a nozzle diameter of the first discharging nozzle.

5. The three-dimensional shaping apparatus according to claim 3, wherein the second formation section includes a discharging head in which the second discharging nozzle is disposed in line.

6. The three-dimensional shaping apparatus according to claim 1, wherein the second formation section includes an application roller configured to apply the second shaping material.

7. The three-dimensional shaping apparatus according to claim 6, wherein a shaping material formed on a surface of the application roller for application of the second shaping material has a thickness greater than a thickness of the outline formed by the first formation section.

8. The three-dimensional shaping apparatus according to claim 1, wherein the second formation section includes:
a planarizing section configured to planarize the discharged or applied second shaping material; and
a curing section configured to perform a curing process for curing the second shaping material planarized by the planarizing section.

9. The three-dimensional shaping apparatus according to claim 1, wherein the first formation section includes a clogging detection section configured to detect clogging of the first discharging nozzle.

10-12. (canceled)

13. A three-dimensional shaping method of shaping a three-dimensional object, the three-dimensional shaping method comprising:
forming an outline of a shaping material layer with a first resolution by discharging a first shaping material toward a shaping stage, wherein the first shaping material has a sol-gel phase transition temperature which is higher than normal temperature and the first shaping material is heated and discharged in a sol phase;
forming an inner portion of the outline with a second resolution lower than the first resolution by supplying a second shaping material toward the shaping stage, wherein the first and second shaping materials have a photosetting property;
forming the shaping material layer by providing the first and second shaping materials onto the shaping stage and curing the shaping material layer by irradiating the light; and
stacking a plurality of shaping material layers on one another.

14. The three-dimensional shaping method according to claim 13 wherein the inner portion of the outline is formed after a formation of the outline of the shaping material layer is started.

15-16. (canceled)

17. The three-dimensional shaping method according to claim 13, wherein:
the shaping material is discharged from a first discharging nozzle toward the shaping stage to form the outline of the shaping material layer; and
clogging of the first discharging nozzle is detected.
